(19) United States
(12) Patent Application Publication
(10) Pub. No.: US 2008/0242348 A1
(43) Pub. Date: Oct. 2, 2008

(54) MOBILE PHONE WITH VITAL SIGNS MEASUREMENT AND DISPLAY CAPABILITIES

(76) Inventor: Kent T.J. Hsu, Taipei (TW)

Correspondence Address: SAM CHEN, 7F-1, 293, ROOSEVELT ROAD, SEC 3, TAIPEI, TW

(21) Appl. No.: 11/692,189

(22) Filed: Mar. 28, 2007

(51) Int. Cl. H04M 1/00

(52) U.S. Cl. 455/556.1

(57) ABSTRACT

A mobile phone includes a control unit having two amplification circuits, an ADC, a control IC, a display circuit, and an inflation control circuit; first and second measurement units; and a releasably attached inflatable wrist band having a sphygmomanometer and an air pump. In response to wrapping the wrist band around the wrist of a user holding the mobile phone with the sphygmomanometer being in contact with the wrist and the hand holding the mobile phone being in contact with the measurement units, the first measurement unit measures body temperature and total calories, the second measurement unit measures pulse, the control IC enables the sphygmomanometer to measure blood pressure, signals about body temperature, total calories, pulse, and blood pressure are processed by the control IC to convert into corresponding data, and the display circuit sends the data representing the vital signs to a display of the mobile phone.

### BACKGROUND OF THE INVENTION

1. Field of Invention

The invention relates to the measurement of vital signs and more particularly to a mobile phone capable of measuring vital signs including body temperature, total calories, pulse, and blood pressure of a person holding the mobile phone and displaying same on a display of the mobile phone in a digital form.

2. Description of Related Art

It is typical for a person to go to a health care provider (e.g., hospital) to take a physical examination. However, taking a physical examination is a time consuming thing as viewed by some people. Further, some people may desire to know only a few things about his or her health rather than going to a hospital to take a complete physical examination.

The availability of mobile phones enables a person to use a mobile phone to communicate with a distant person using a typical wire telephone (or mobile phone) in any time any place. Hence, mobile phones have become a ubiquitous communications tool in our daily life. It is thus desirable to provide an improved mobile phone capable of measuring vital signs and displaying same on a display thereof in a digital form.

### SUMMARY OF THE INVENTION

It is therefore one object of the invention to provide a mobile phone capable of measuring vital signs including body temperature, total calories, pulse, and blood pressure of a person holding the mobile phone and displaying same on a display of the mobile phone in a digital form.

The above and other objects, features and advantages of the invention will become apparent from the following detailed description taken with the accompanying drawings.

### BRIEF DESCRIPTION OF THE DRAWINGS

FIG. 1 is a perspective view of a preferred embodiment of the invention; and

FIG. 2 is a block diagram of the preferred embodiment of the invention.

### DETAILED DESCRIPTION OF THE INVENTION

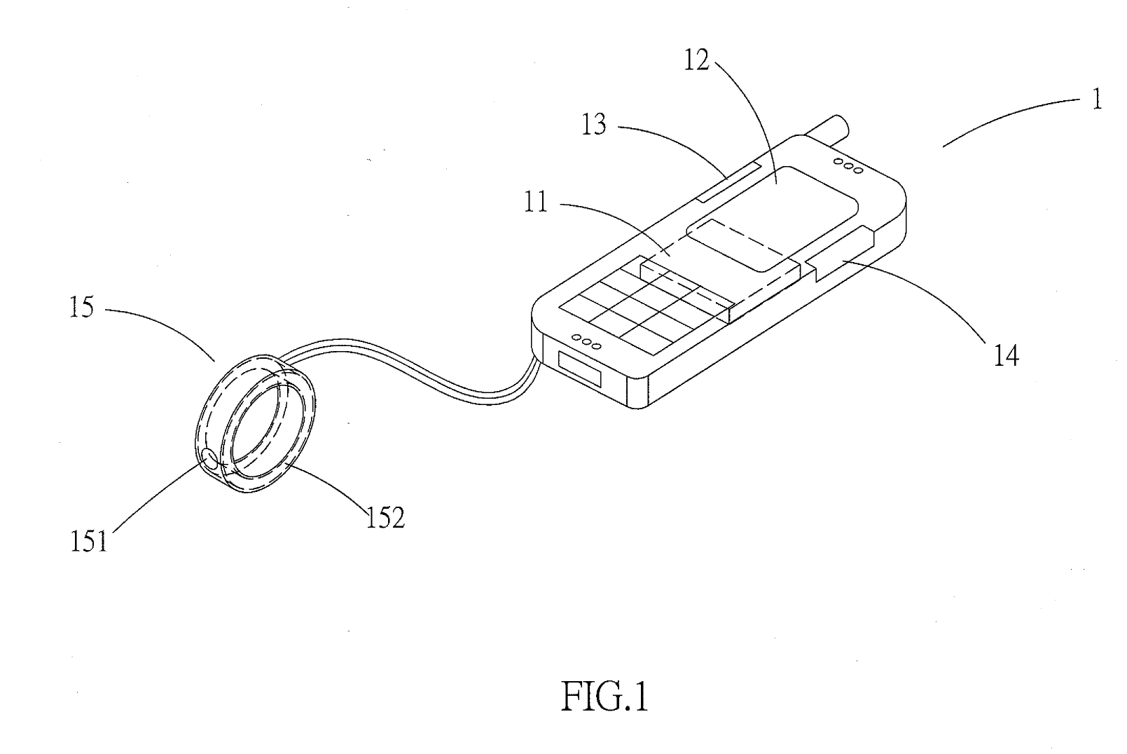

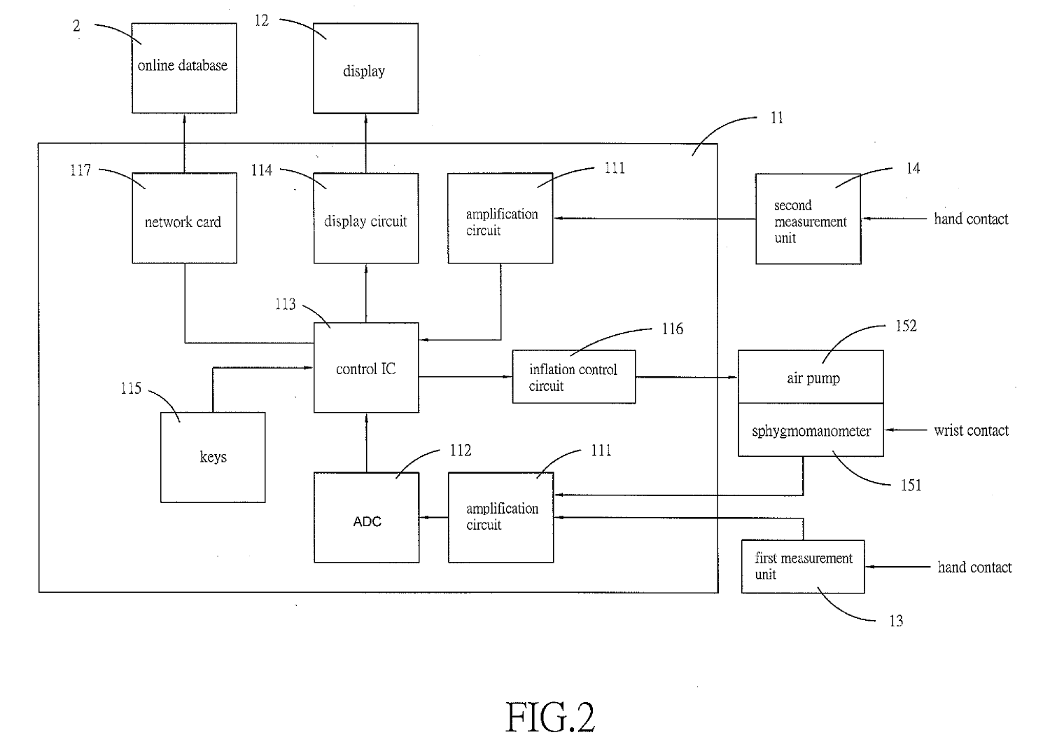

Referring to FIGS. 1 and 2, a mobile phone 1 in accordance with a preferred embodiment of the invention is shown. The mobile phone 1 comprises a control unit 11 provided within the phone body, a display 12 provided on a front surface, a first measurement unit 13 provided on a left side, and a second measurement unit 14 provided on a right side. Each component is discussed in detailed below.

In the embodiment, the first measurement unit 13 is adapted to measure both body temperature and total calories and the second measurement unit 14 is adapted to measure pulse respectively.

An additional inflatable wrist band 15 is provided and is releasably attached to the control unit 11 by wire. The wrist band 15 comprises a sphygmomanometer 151 adapted to measure blood pressure, and an air pump 152 adapted to inflate the wrist band 15 to tighten the wrist.

The control unit 11 comprises two amplification circuits 111, an ADC (analog to digital converter) 112, a control integrated circuit (IC) 113, a display circuit 114, a plurality of keys 115, an inflation control circuit 116, and a network card 117.

An operation of the invention will be described in detailed below. The wrist of a user is wrapped around by the wrist band 15 with the sphygmomanometer 151 being in contact with the wrist and the hand holding the mobile phone 1 is being in contact with both the measurement units 13 and 14.

The first measurement unit 13 is adapted to measure both body temperature and total calories. The measured body temperature and total calories are converted into a first signal which is in turn sent to one amplification circuit 111 for amplification. The amplified first signal is then sent to the ADC 112 for converting into a first digital signal. The first digital signal is then sent to the control IC 113 for processing.

The second measurement unit 14 is adapted to measure pulse of the user. The measured pulse is converted into a second signal which is in turn sent to the other amplification circuit 111 for amplification. The amplified second signal is then sent to the control IC 113 for processing.

And in turn, the control IC 113 generates a third signal to the inflation control circuit 116. The inflation control circuit 116 is enabled to generate a fourth signal and send same to the air pump 152 for activation so as to inflate the wrist band 15 for tightening the wrist. Also, the sphygmomanometer 151 is enabled to measure blood pressure. The measured blood pressure is converted into a fifth signal. The fifth signal is in turn sent to one amplification circuit 111 for amplification. The amplified fifth signal is then sent to the ADC 112 for converting into a second digital signal. The second digital signal is then sent to the control IC 113 for processing.

After the processing, the control IC 113 sends signals about body temperature, total calories, pulse, and blood pressure to the display circuit 114 for further processing into corresponding data representing body temperature, total calories, pulse, and blood pressure which are then sent to the display 12 for display in a digital form.

In addition, after the processing, the control IC 113 sends signals about body temperature, total calories, pulse, and blood pressure to an online database 2 over the Internet via the network card 117.

The provision of the keys 115 is for setting purpose.

While the invention herein disclosed has been described by means of specific embodiments, numerous modifications and variations could be made thereto by those skilled in the art without departing from the scope and spirit of the invention set forth in the claims.

What is claimed is:

1. A mobile phone comprising:
a body;
a control unit in the body and comprising a first amplification circuit, a second amplification circuit, an ADC (analog to digital converter), a control integrated circuit (IC), a display circuit, a plurality of setup keys, and an inflation control circuit;
a display on a front surface of the body;
a first measurement unit on one side of the body;
a second measurement unit on the other side of the body; and
an inflatable wrist band releasably attached to the control unit for communicating signals therewith, the wrist band comprising a sphygmomanometer and an air pump,
wherein in response to wrapping the wrist band around the wrist of a user holding the mobile phone with the sphygmomanometer being in contact with the wrist and the hand holding the mobile phone being in contact with the first and the second measurement units, (a) the first measurement unit is adapted to measure body temperature and total calories of the user and convert same into a first signal which is sent to the first amplification circuit for amplification, the amplified first signal is sent to the ADC for converting into a first digital signal, and the first digital signal is sent to the control IC for processing; (b) the second measurement unit is adapted to measure pulse of the user and convert same into a second signal which is sent to the second amplification circuit for amplification, and the amplified second signal is sent to the control IC for processing; (c) the control IC generates a third signal to enable the inflation control circuit for generating a fourth signal which is sent to the air pump for activation so as to inflate the wrist band for tightening the wrist, the sphygmomanometer is enabled by the inflation control circuit to measure blood pressure of the user, the measured blood pressure is converted into a fifth signal which is sent to the first amplification circuit for amplification, and the amplified fifth signal is sent to the ADC for converting into a second digital signal which is sent to the control IC for processing; and (d) the control IC sends the processed signals about body temperature, total calories, pulse, and blood pressure of the user to the display circuit for processing into corresponding data representing body temperature, total calories, pulse, and blood pressure of the user, and the display circuit sends the data representing body temperature, total calories, pulse, and blood pressure of the user to the display for display in a digital form.

2. The mobile phone of claim 1, wherein the control unit further comprises a network card, the network card adapted to send the processed signals about body temperature, total calories, pulse, and blood pressure of the user over the Internet.
